(19) United States
(12) Patent Application Publication
(10) Pub. No.: US 2007/0009007 A1
(43) Pub. Date: Jan. 11, 2007

(54) Vessel having temperature monitoring apparatus

(76) Inventors: Paul Nicholls, Southampton (GB); Yan Meisong, Sugar Land, TX (US)

Correspondence Address: Schlumberger Technology Corporation;Schlumberger Reservoir Completions, Patent Counsel, 14910 Airline Road, Rosharon, TX, 77583, US

(21) Appl. No.: 10/530,502

(22) PCT Filed: Oct. 2, 2003
(86) PCT No.: PCT/GB03/04288

§ 371 Date: Aug. 21, 2006

(30) Foreign Application Priority Data
Oct. 7, 2002 (GB) 02232189

(51) Int. Cl. G01N 25/00

(52) U.S. Cl. 374/10

(57) ABSTRACT

A vessel (2) comprising a body (4), a conduit (6) disposed near the body (4), a distributed temperature sensor system (12) for monitoring temperatures in the body (4) and comprising an optical fibre (14) positioned in the conduit (6), and the conduit and optical fibre (14) extending such that they provide a temperature profile of temperatures in at least a portion of the body (4).

This invention relates to a vessel and, more especially, this invention relates to a vessel having a distributed temperature sensor system capable of monitoring the temperature at a product flowing within the vessel.

Vessels are used in many different types of industrial processes and may include vessels that are at a positive, negative, or atmospheric pressure. Typically, industrial vessels are used in refineries, petrochemical plants and chemical plants and may be used to separate liquid components from a feed material. Processes carried out in industrial vessels are often highly dependent upon the temperatures within the vessel. Often precise temperatures must be achieved and maintained at different areas of an industrial vessel in order to ensure that the process is functioning properly and the resulting product is within desired parameters.

The known industrial vessels often do not have adequate temperature monitoring apparatus for enabling optimum operation of the vessels. It is an aim of the present invention to obviate or reduce this problem.

Accordingly, in one non-limiting embodiment of the present invention there is provided an industrial vessel comprising a body, a conduit disposed near the body, a distributed temperature sensor system for monitoring temperatures in the body and comprising optical fibre positioned in the conduit, and the conduit and the optical fibre extending such that they provide a temperature profile of temperatures in at least a portion of the body.

The vessel of the present invention is advantageous in that the temperature of a product flow through the pressure vessel is able to be precisely monitored. Products flowing through the vessel are able to be maintained at desired temperatures in order to ensure that the vessel is operating in an optimum manner.

The conduit gives mechanical protection for the optical fibre. The conduit may be located on the outside or on the inside of the body.

The industrial vessel may include a control system for controlling the process and product flow within the body consequent upon the temperature measurements obtained by the distributed temperature sensor. The control system may be a dynamic loop between the distributed temperature sensor and the process/product controls such that certain inputs, outputs, or envision mantal characteristics are changed or controlled (based on desired parameters) automatically depending on the sensed temperature profile.

The conduit may take any suitable and appropriate path relative to the body. Thus, for example, the conduit may be in the form of a coil extending lengthwise along the body. The conduit may be mechanically attached by any suitable and appropriate means, for example welding or brackets, to the body.

The conduit may be a metal conduit. A presently preferred metal conduit is stainless steel. Other metals may be employed for the conduit including high temperature alloys. The high temperature alloys may be nickel:steel alloys or molybdenum alloys. Those alloys sold under the registered trade marks of Duplex and Hastelloy may be employed. The conduit may also be constructed from other materials that can conduct heat.

The industrial vessel may be one in which the body has at least two feed points for feeding the optical fibre to and from the conduit. With such feed points a new optical fibre may be pumped into the vessel or a defective optical fibre may be replaced with a new optical fibre.

The industrial vessel may be one in which the body has at least one pressure sensing point for connection to at least one pressure sensing means for sensing pressures within the body. By way of example, it is mentioned that there may be two of the pressure sensing means, with one of the pressure sensing means being located at a product inlet on the body, and the other pressure sensing means being located at a product outlet on the body. The vessel of the present invention may be manufactured and sold with or without the actual pressure sensing means. The pressure sensing means may be regarded as a pressure transducer. Pressure measurements together with the temperature at the location of the pressure sensing means may be used to determine the actual composition of a fluid product in the vessel, for example to determine the actual composition of a hydrocarbon liquid.

The use of the optical fibre optic is advantageous in that it does not cause electrical interference and/or sparks as might be the case if an electrical device were to be employed. Optical fibres with distributed temperature sensing capability are especially suitable for allowing temperatures to be sensed at many separate points along the entire length of the optical fibre. The optical fibre is typically connected to an interrogation unit.

An embodiment of the invention will now be described solely by way of example and with reference to the accompanying drawings in which:

FIG. 1 shows part of an industrial vessel having a distributed temperature sensor system;

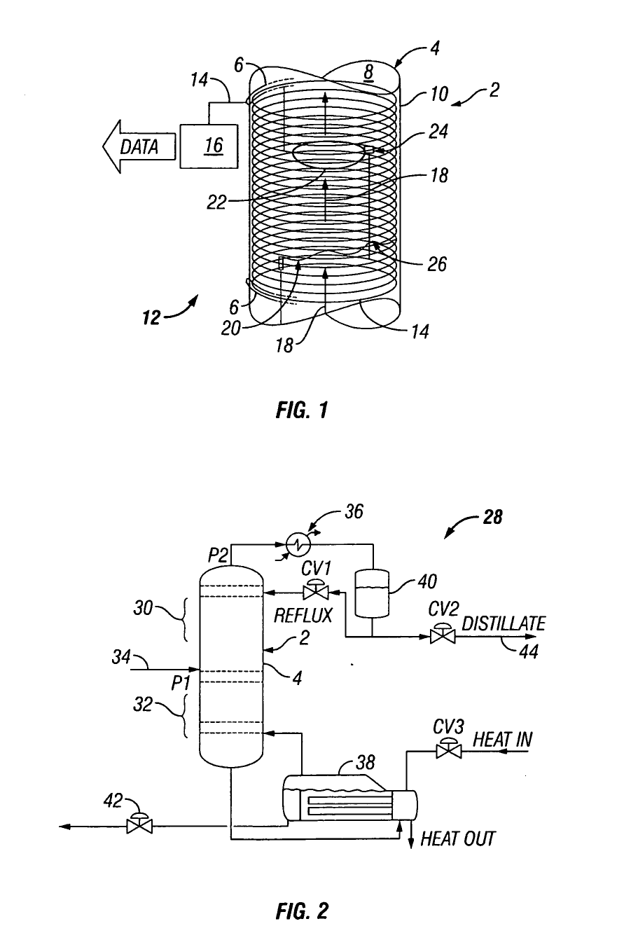

FIG. 2 shows a system utilising the vessel shown in FIG. 1;

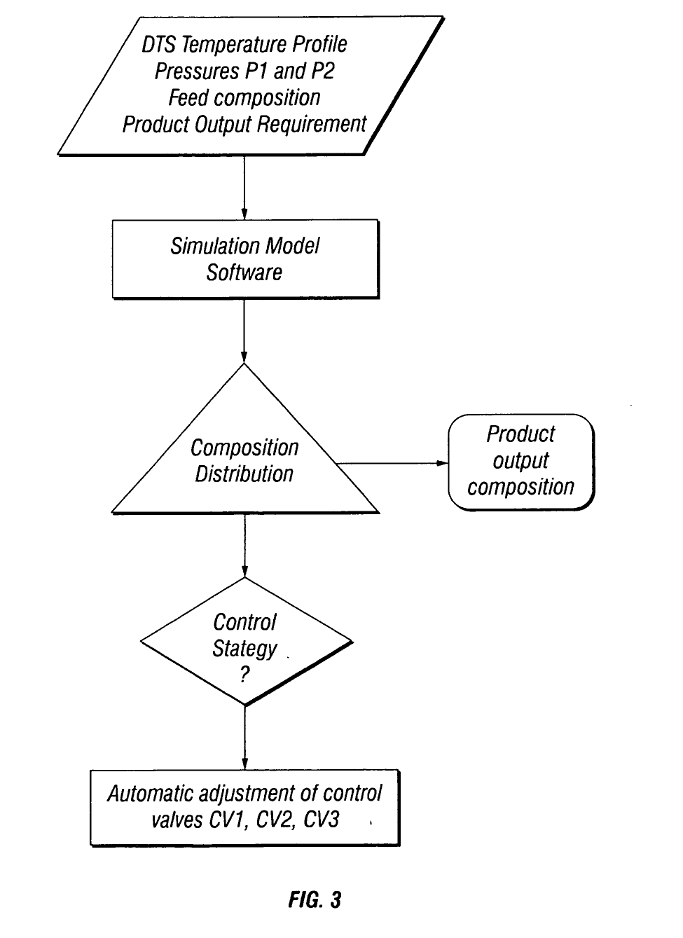

FIG. 3 is a flow chart showing the operation of software that may be used in the system shown in FIG. 2; and

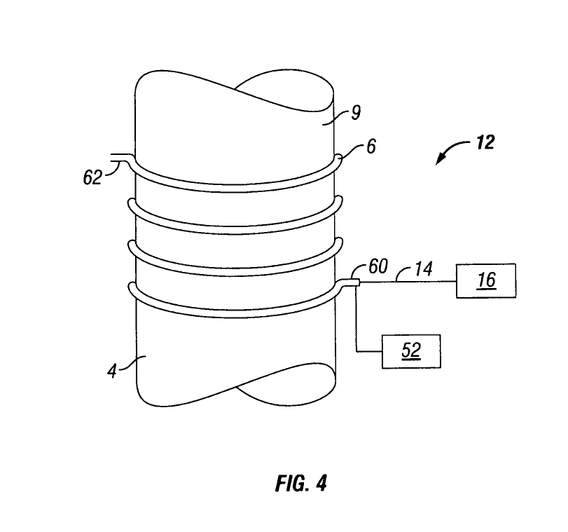

FIG. 4 is an alternative embodiment of the distributed temperature sensor system.

Referring to FIG. 1, there is shown part of an industrial vessel 2 having a body 4. A conduit 6 is located near the body 4. For simplicity of illustration, only part of the conduit 6 has been shown. In the embodiment of FIG. 1, the conduit 6 is attached to the inside 8 of a wall 10 of the body 4. However, as shown in FIG. 4, the conduit 6 may also be attached to the outside of the wall 10.

The industrial vessel 2 includes a distributed temperature sensor system 12 for monitoring temperatures in the body 4. The distributed temperature sensor system 12 comprises an optical fibre 14 positioned in the conduit 6 and an interrogation unit 16 which is connected to the optical fibre 14 as shown. The interrogation unit 16 may be positioned outside the body 4 and is an opto-electric unit adapted to receive the readings from the optical fibre 14 and determine the temperatures sensed by the optical fibre 14 including their relative location along the length of the optical fibre 14.

As can be seen from FIG. 1, the conduit 6 and the optical fibre 14 may extend over a substantial part of the length of the body 4. This thereby enables the distributed temperature sensor system 12 to obtain measurements at a plurality of different areas in the body 4. The distributed temperature sensor system 12 is then able to provide a temperature profile of temperatures in the body 4 and is able to monitor whether the process taking part in, and the product flowing through, the vessel 2 are within the desired parameters. Knowing the temperature profile along the vessel 2 and at differing stages of the product flow within the vessel 2 allows the entire process and product flow to be monitored. This in turn enables an operator to descern the location of any problems or faults in the process and product flows, such as by determining the location of a reading which is outside the desired parameters. The problem or fault can then be isolated and addressed.

The distributed temperature sensor system 12 may operate such that pulses of light at a fixed wavelength are transmitted from the interrogation unit 16 (which is also includes a source of light) along the optical fibre 14. At every measurement location in the optical fibre 14, the light is back-scattered and it returns to the interrogation unit 16. Knowing the speed of light and the moment of arrival of the return signal, enables its point of origin along the optical fibre 14 to be determined. Temperature stimulates the energy levels of silica molecules in the optical fibre 14. The back-scattered light contains upshifted and downshifted wavebands (such as the Stokes Raman and Anti-Stokes Raman portions of the back-scattered spectrum) which can be analysed to determine the temperature at origin. In this way, the temperature of each of the responding measurement points in the optical fibre 4 can be calculated by the interrogation unit 16, providing a complete temperature profile along the length of the optical fibre 14 and thus along the length of the body 4 of the vessel 2.

The exemplary vessel 2 shown in FIG. 1 has vapour rising as shown by arrow 18, and liquid 20 moving towards a bottom part of the body 4 for appropriate take off. Positioned within the body 4 are a tray 22, an outlet weir 24 and a downcomer 26. The distributed temperature sensor system 12 would enable an operator to ensure that the product flow and process are acceptable for the different stages, such as by being able to tell whether the temperature at tray 12, outlet weir 24 or downcomer 26 are within acceptable ranges to provide a satisfactory output product from vessel 2.

FIG. 2 shows the vessel 2 of FIG. 1 in an entire distillation system 28. The distillation system 28 may typically be that used in a refinery, a petrochemical plant, or a chemical plant in order to separate liquid components for subsequent processing. As shown in FIG. 2, the vessel 2 has an enriching section 30 and a stripping section 32. Product feed is fed to the vessel 2 at a feed point 34.

The system 28 also has a condenser 36, control valves CV1, CV2 and CV3, and a reboiler 38. Also provided in the system 28 are a reflux drum 40 and a valve 42 for bottoms.

The system 28 operates such that distillate is obtained as shown from the control valve CV2, the distillate being the required product output. The temperature gradient within the body 4 is controlled by the flow of reflux, (control by control valves CV1 and CV2) and reboiler (controlled by controlled valve CV3). The control afforded by the valves CV1, CV2 and CV3 provides for the correct composition in the product output shown as distillate 44.

The temperature profile of the product in the pressure vessel 2 is obtained by the distributed temperature sensor system 12.

The vessel 2 may be regarded as having a body which is a vertical column where the separation of liquid components of a liquid product feed takes place. The body 4 may contain appropriate trays/plates and/or packings as required in order to enhance the separation of the liquid components. The vessel 2 may be arranged to operate such that there are internal flows of vapour and liquid within the body 4. Separation of the liquid components from the liquid product feed depends on differences in boiling points of the individual components. Optimum distillation is able to be achieved due to the accurate temperature monitoring afforded by the use of the distributed temperature sensor system 12. If the temperature measurements are outside desired parameters (to provide a satisfactory product) at any of the process phases, an operation may change the input parameters, such as by controlling valves CV1, CV2, or CV3, to bring the temperature (and therefore the product) within an acceptable range. In another embodiment (as shown in FIG. 2), a control unit 50, such as a computer processor, automatically controls the input parameters depending on the temperature measurements in order to provide an acceptable product. In this embodiment, the control unit 50 is functionally connected to the interrogation unit 7 and to the input parameters, such as control valves CV1, CV2 and CV3.

The temperature data obtained can be fed into a graphic user interface which can graphically present the temperature distribution. Software may then be employed to interpret the data in order to provide operational and process information for optimisation and control. FIG. 3 shows an example of such software.

In one embodiment as shown in FIG. 2, pressure measurements are able to be taken at a feed inlet P1 and a product outlet P2. There may be more than one feed inlet P1 and product outlet P2, but only one such inlet and outlet have been shown in FIG. 2 for ease of illustration. The pressure measurements, the temperature profile obtained from the distributed temperature sensor 16, the liquid product feed composition, and the product output requirement are fed to simulation model software. The composition distribution is then obtained, giving a required product output composition and a control strategy as shown in the flow diagram of FIG. 3. Automatic adjustment of the control valves CV1, CV2 and CV3 can then take place in order to obtain optimum operating conditions.

The pressure vessel 2 can be operated to give the following benefits.
Since the body 4 usually has a number of feed tray locations to suit different feed stock, temperature readings may be used for inferential control, cascade control or other control parameters.
Since the condition of the feed stock is always changing, for example due to outside temperature and pressure changes, composition changes etc., the final separation requirement for the optimum result may be achieved by monitoring and controlling the temperature in the body 4.
Temperature measurements throughout the column 4 allow overall real-time close-loop plant-wide optimisation.

The apparatus of the present invention is also advantageous in the following:
One-time installation is able to suit all different feed compositions and conditions.
One-time installation is able to suit all temperature control requirements since the temperature sensitive location will migrate due to process change.
Accurate temperature measurements for process control and optimisation are able to be achieved.
Since complete temperature profiles are available, abnormal operation can be determined at a very early stage.
Options are available for easily replacing the fibre optic cable within the conduit by pumping the optical fibre from outside the body 4.

In one embodiment, in order to install optical fibre 14, optical fibre 14 may be pumped through the conduit 6. This pumping technique is generally described in U.S. Reissue Pat. No. 37,283. Essentially, the optical fibre 14 is charged along the conduit 6 by the injection of a fluid by a pump 52 at the inlet 60 of the conduit 6 (see FIG. 4). The fluid injection pressure works to drag the optical fibre 14 along the conduit 6. This pumping technique is useful when conduit 6 also has an outlet 62 so as to allow the flow of and therefore drag caused by the pressured fluid. This technique can also be used to retrieve an optical fibre 14 the conduit 6, such as if it is damaged, and then install a new optical fibre 14 therein.

It is to be appreciated that the embodiment of the invention described above with reference to the accompanying drawings has been given by way of example only and that modifications may be effected. Thus, for example, the vessel 2 may be for use other than the illustrated distillation column, any product or process may be monitored and a pressure reading may be used to obtain the composition distribution at any point.

1. A vessel, comprising:
a body;
a conduit disposed near the body;
a distributed temperature system for monitoring temperature in the body and comprising an optical fiber positioned in the conduit; and
the conduit and the optical fiber extending such that they provide a temperature profile of temperatures in at least a portion of the body.

2. The vessel of claim 1, further comprising a control unit for automatically controlling parameters in the body depending on the temperature profile obtained by the distributed temperature system.

3. The vessel of claim 1, wherein the conduit is a metal conduit.

4. The vessel of claim 3, wherein the metal conduit is constructed from stainless steel.

5. The vessel of claim 1, wherein the conduit is located outside of the body.

6. The vessel of claim 1, wherein the conduit is located inside of the body.

7. The vessel of claim 1, wherein the optical fiber is pumped into the conduit by way of fluid drag.

8. The vessel of claim 1, wherein:
a process is performed within the vessel; and
a control unit automatically controls parameters in the body depending on the temperature profile to ensure that the process is within an acceptable range.

9. The vessel of claim 8, wherein at least one of the parameters is pressure.

10. The vessel of claim 8, wherein at least one of the parameters is temperature.

11. The vessel of claim 8, wherein:
the process has a plurality of stages within the vessel; and
the control unit controls the parameters in the body depending on the temperature profile to ensure that each stage of the process is within an acceptable range.

12. The vessel of claim 1, wherein the vessel is part of a distillation system.

13. The vessel of claim 12, wherein the distillation system separates liquid components for subsequent processing.

14. The vessel of claim 1, wherein vapour enters the vessel at one end of the vessel and liquid enters the vessel at another end of the vessel.

15. The vessel of claim 14, wherein the vapour enters at a top end of the vessel and the liquid enters at a bottom end of the vessel.

16. The vessel of claim 1, further comprising:
a plurality of valves that control parameters within the body; and
the parameters are controlled depending on the temperature profile to ensure that a process taking part in the body is within an acceptable range.

17. The vessel of claim 16, further comprising a control unit for automatically controlling the parameters depending on the temperature profile to ensure that a process taking part in the body is within an acceptable range.

18. A method for monitoring a vessel, comprising:
disposing a conduit near a body of the vessel;
monitoring temperature in the body by use of a distributed temperature system including an optical fiber that is located within the conduit; and
extending the conduit and the optical fiber such that they provide a temperature profile of temperatures in at least a portion of the body.

19. The method of claim 18, further comprising automatically controlling parameters in the body depending on the temperature profile obtained by the distributed temperature system.

20. The method of claim 18, wherein the disposing step comprises disposing the conduit outside of the body.

21. The method of claim 18, wherein the disposing step comprises disposing the conduit inside of the body.

22. The method of claim 18, further comprising pumping the optical fiber into the conduit by way of fluid drag.

23. The method of claim 18, further comprising:
performing a process within the vessel; and
automatically controlling parameters in the body depending on the temperature profile to ensure that the process is within an acceptable range.

24. The method of claim 23, wherein at least one of the parameters is pressure.

25. The method of claim 23, wherein at least one of the parameters is temperature.

26. The method of claim 23, further comprising automatically controlling the parameters depending on the temperature profile to ensure that each of a plurality of stages of the process is within an acceptable range.

27. The method of claim 18, further comprising separating liquid components in the vessel for subsequent processing.

28. The method of claim 18, further comprising feeding vapour at one end of the vessel and feeding liquid at another end of the vessel.

29. The method of claim 28, further comprising feeding vapour at a top end of the vessel and feeding liquid at a bottom end of the vessel.

30. The method of claim 18, further comprising:
controlling parameters within the body by the use of a plurality of valves; and
controlling the parameters depending on the temperature profile to ensure that a process taking part in the body is within an acceptable range.

31. The method of claim 30, further comprising automatically controlling the parameters depending on the temperature profile to ensure that a process taking part in the body is within an acceptable range.
